(19) United States
(12) Patent Application Publication
(10) Pub. No.: US 2013/0227480 A1
(43) Pub. Date: Aug. 29, 2013

(54) APPARATUS AND METHOD FOR SELECTING OBJECT IN ELECTRONIC DEVICE HAVING TOUCHSCREEN

(71) Applicant: Samsung Electronics Co., Ltd., (US)

(72) Inventors: Young-Ho KIM, Hwaseong-si (KR); Tae-Sung CHOI, Seoul (KR)

(73) Assignee: SAMSUNG ELECTRONICS CO. LTD., Suwon-si (KR)

(21) Appl. No.: 13/774,106

(22) Filed: Feb. 22, 2013

(30) Foreign Application Priority Data
Feb. 24, 2012 (KR) 10-2012-0018915

(51) Int. Cl. G06F 3/0481

(52) U.S. Cl. CPC G06F 3/04817
USPC 715/810

(57) ABSTRACT

An apparatus and a method for selecting an object in an electronic device having a touchscreen are provided. The method for selecting an object, includes when a first touch is detected, setting a point of the first touch as a first reference point, and when movement of touch points from the first touch point is detected, selecting at least two objects, included in a first object selection area according to the first touch point and a first movement path of the touch points.

### PRIORITY

This application claims the benefit under 35 U.S.C. §119(a) of a Korean patent application filed on Feb. 24, 2012 in the Korean Intellectual Property Office and assigned Serial No. 10-2012-0018915, the entire disclosure of which is hereby incorporated by reference.

### BACKGROUND OF THE INVENTION

1. Field of the Invention

The present invention relates to an electronic device having a touchscreen. More particularly, the present invention relates to an apparatus and method for selecting an object in an electronic device. The object includes an application icon, a widget, a thumbnail image, or the like.

2. Description of the Related Art

Portable terminals have become ubiquitous in modern society due to their portability, and have evolved into multimedia devices that provide various services such as voice and video call functions, an information input/output function, and a data storage function.

As multimedia services have been provided in a portable electronic device, the amount of information to be processed and the amount of information to be displayed have increased. As a result, there is a growing interest in an electronic device having a touchscreen in which the space thereof is efficiently used and the size of the display unit thereof is increased.

A touchscreen is an input/output device for performing the input and display of information on one screen. Therefore, when a portable electronic device includes a touchscreen, the display area of the portable electronic device can be increased by eliminating a separate input device, such as a keypad.

As described above, the portable electronic device can provide a variety of multimedia services to a user through a larger screen using the touchscreen. However, the portable electronic device having the touchscreen has a different manipulation method from a portable electronic device having a separate input device, such as a keypad.

As a result, the electronic device having the touchscreen requires a user interface specified for the touchscreen.

Therefore, a need exists for an apparatus and method for selecting an object in an electronic device having a touchscreen.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages below. Accordingly, an aspect of the present invention is to provide an apparatus and method for selecting an object in an electronic device having a touchscreen.

Another aspect of the present invention is to provide an apparatus and method for selecting a plurality of objects in an electronic device having a touchscreen.

Yet another aspect of the present invention is to provide an apparatus and method for decreasing time latency caused by selecting a plurality of objects in an electronic device having a touchscreen.

Still another aspect of the present invention is to provide an apparatus and method for selecting a plurality of adjacent objects simultaneously in an electronic device having a touchscreen.

In accordance with a first aspect of the present invention, a method for selecting an object in an electronic device having a touchscreen is provided. The method includes when a first touch is detected, setting a point of the first touch as a first reference point, and when movement of touch points from the first touch point is detected, selecting at least two objects, included in a first object selection area according to the first touch point and a first movement path of the touch points.

In accordance with a second aspect of the present invention, an apparatus for selecting an object in an electronic device is provided. The apparatus includes a touchscreen for displaying at least one object and receiving touch information, and a control unit for, when a first touch is detected, setting a point of the first touch as a first reference point, and, when movement of touch points from the first touch point is detected, selecting at least two objects included in a first object selection area according to the first touch point and a first movement path of the touch points.

In accordance with a third aspect of the present invention, a method for selecting an object in an electronic device having a touchscreen is provided. The method includes when a first touch is detected, setting a point of the first touch as a first reference point, and when a second touch is detected, selecting at least two objects, included in an object selection area according to the first touch point and a point of a second touch.

In accordance with a fourth aspect of the present invention, an apparatus for selecting an object in an electronic device is provided. The apparatus includes a touchscreen for displaying at least one object and receiving touch information, and a control unit for, when a first touch is detected, setting a point of the first touch as a first reference point and, when a second touch is detected, selecting at least two objects, included in an object selection area according to the first touch point and a point of a second touch.

In accordance with a fifth aspect of the present invention, a method for selecting an object in an electronic device having a touchscreen is provided. The method includes when a first touch is detected, determining whether an object selection event is generated in consideration of a touch duration time of the first touch, when the object selection event is generated, determining whether at least two touches are detected, and when a second touch and a third touch are detected, selecting at least two objects, included in an object selection area according to a point of the second touch and a point of the third touch.

In accordance with a sixth aspect of the present invention, an apparatus for selecting an object in an electronic device is provided. The apparatus includes a touchscreen, and a control unit for, when a first touch is detected, determining whether an object selection event is generated in consideration of a touch duration time of the first touch, and, when the object selection event is generated, selecting at least two objects, included in an object selection area according to a second touch point and a third touch point at which a second touch and a third touch are detected.

In accordance with a seventh aspect of the present invention, a method for selecting an object in an electronic device having a touchscreen is provided. The method includes when a selection event is generated, determining whether a touch on at least one object is detected, and, when the touch on at least one object is detected, selecting the touched at least one object.

In accordance with an eighth aspect of the present invention, an apparatus for selecting an object in an electronic device is provided. The apparatus includes a touch screen, and a control unit for, when a selection event is generated, determining whether a touch on at least one object is detected, and, when the touch on at least one object is detected, selecting the touched at least one object.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will become more apparent from the following detailed description when taken in conjunction with the accompanying drawings in which:

FIG. 1 illustrates a block configuration of an electronic device having a touchscreen according to an exemplary embodiment of the present invention;

FIG. 2 illustrates a process for selecting an object in an electronic device having a touchscreen according to a first exemplary embodiment of the present invention;

FIGS. 3A and 3B illustrate screen configurations for object selection in the electronic device having a touchscreen according to the first exemplary embodiment of the present invention;

FIG. 4 illustrates a process for selecting an object in an electronic device having a touchscreen according to a second exemplary embodiment of the present invention.

FIGS. 5A through 5D illustrate screen configurations for object selection in the electronic device having a touchscreen according to the second exemplary embodiment of the present invention;

FIG. 6 illustrates a process for selecting an object in an electronic device having a touchscreen according to a third exemplary embodiment of the present invention;

FIGS. 7A and 7B illustrates a screen configuration for object selection in the electronic device having a touchscreen according to the third exemplary embodiment of the present invention;

FIG. 8 illustrates a process for selecting an object in an electronic device having a touchscreen according to a fourth exemplary embodiment of the present invention.

FIGS. 9A and 9B illustrate screen configurations for object selection in the electronic device having a touchscreen according to the fourth exemplary embodiment of the present invention;

FIGS. 10A and 10B illustrate screen configurations for object selection in the electronic device having a touchscreen according to a fifth exemplary embodiment of the present invention;

FIG. 11 illustrates a process for selecting an object in an electronic device having a touchscreen according to the fifth exemplary embodiment of the present invention; and

FIGS. 12A and 12B illustrate screen configurations for object selection in the electronic device having a touchscreen according to a sixth exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, a technology of selecting an object in an electronic device having a touchscreen according to exemplary embodiments of the present invention will be described below. The object includes an application icon, a widget, a thumbnail image, and the like.

Examples of the electronic device including a touchscreen may include a mobile terminal having a touchscreen, a Personal Digital Assistant (PDA), a laptop computer, a smart phone, a netbook, a Mobile Internet Device (MID), an Ultra Mobile Personal Computer (UMPC), a tablet Personal Computer (PC), a navigation device, a digital audio player, and the like.

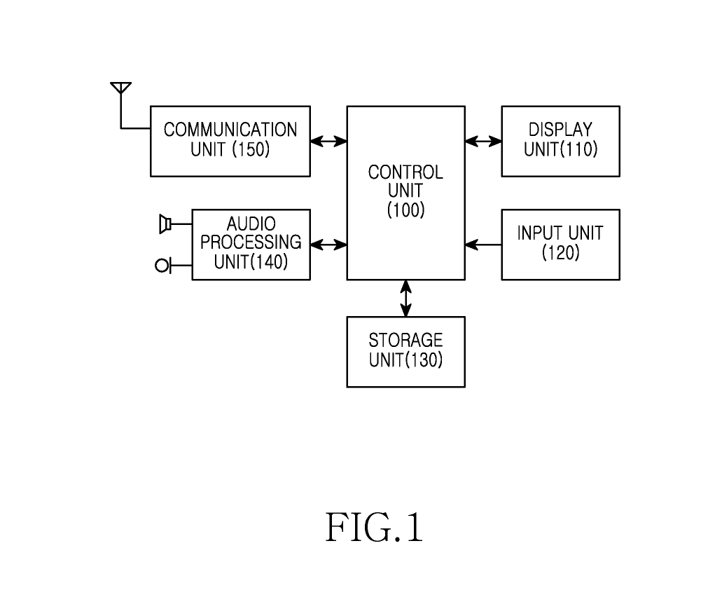

FIG. 1 illustrates a block configuration of an electronic device having a touchscreen according to an exemplary embodiment of the present invention.

In FIG. 1, it is assumed that the electronic device having a touchscreen includes a communication unit for transmitting and receiving signals through an antenna. However, an electronic device having a touchscreen which does not include a communication unit is capable of similarly selecting an object.

Referring to FIG. 1, an electronic device having a touchscreen includes a control unit 100, a display unit 110, an input unit 120, a storage unit 130, an audio processing unit 140, and a communication unit 150.

The control unit 100 controls an overall operation of the electronic device.

The control unit 100 selects a plurality of objects adjacent to each other in consideration of touch information provided from the display unit 110. For example, when drag information of a screen is detected, the control unit 100 may selects objects existing on a drag path.

In another example, the control unit 100 activates an object selection mode when an object touch is maintained for a predetermined time period or more. Thereafter, when a drag is detected on the screen, the control unit 100 selects objects existing on a drag path from a reference point at which an object is touched. In this case, the control unit 100 may additionally select at least one object in consideration of additional touch information generated according to another selection event.

In another example, when an object selection event is generated, the control unit 100 activates an object selection mode. Thereafter, when a drag is detected on the screen, the control unit 100 sets an object selection area in consideration of information about dragging from the reference point. In this case, the control unit 100 selects at least one object included in the object selection area.

In another example, when an object selection event is generated, the control unit 100 activates an object selection mode. Thereafter, when additional touch information is detected, the control unit 100 sets an object selection area in consideration of the reference point and an additional touch point. In this case, the control unit 100 selects at least one object included in the object selection area.

The display unit 110 is configured by a touchscreen, and displays status information of the electronic device having the touchscreen, characters input by a user, moving pictures, still pictures, and the like according to control of the control unit 100. In addition, the display unit 110 provides touch information to the control unit 100. For example, the display unit 110 displays at least one object. In this case, the display unit 110 displays selection such that an object selected by the control unit 100 is distinguished from unselected objects.

The input unit 120 provides the control unit 100 with input data generated by user selection. For example, the input unit 120 may include only a control button for control of the electronic device having a touchscreen. As another example, the input unit 120 may include a keypad for receiving input data from a user.

The storage unit 130 may include a program storage unit for storing a program for controlling an operation of the electronic device having a touchscreen, and a data storage unit for storing data generated during the execution of a program.

The audio processing unit 140 controls the input/output of audio signals. For example, the audio processing unit 140 outputs an audio signal received from the control unit 100 to the outside through a speaker, and provides an audio signal received from a microphone to the control unit 100.

The communication unit 150 processes signal signals transmitted/received through an antenna.

Exemplary embodiments for a method for selecting an object in consideration of touch information in an electronic device having a touchscreen configured as described above are described below in detail.

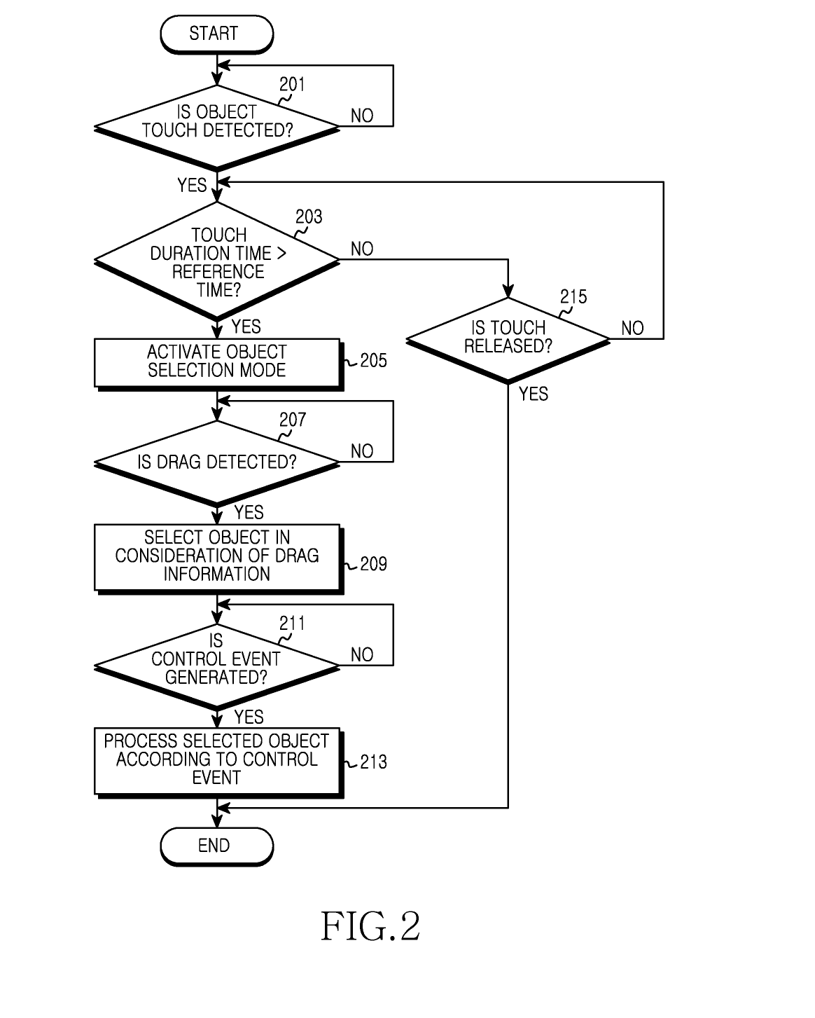

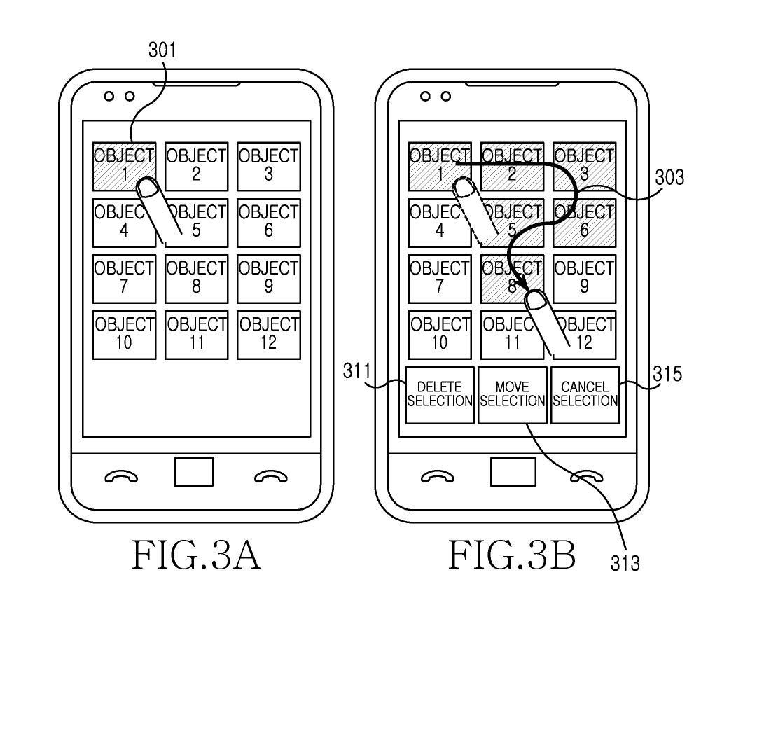

FIG. 2 illustrates a process for selecting an object in an electronic device having a touchscreen according to a first exemplary embodiment of the present invention. FIGS. 3A and 3B illustrate screen configurations for object selection in the electronic device having a touchscreen according to the first exemplary embodiment of the present invention.

Referring to FIGS. 2 through 3B, an electronic device having a touchscreen determines whether an object touch is detected in step 201. That is, the electronic device determines whether a touch on object 1 301 is detected as illustrated in FIG. 3A. When the object touch is not detected, the electronic device returns to step 301.

When the object touch is detected, the electronic device compares the duration time of the touch on the object with a reference time in step 203. That is, the electronic device determines whether the duration time of the touch on the object exceeds the reference time.

When the duration time of the touch on the object is smaller than or identical to the reference time, the electronic device determines whether the touch on the object is released in step 215.

When the touch on the object has been released, the electronic device ends the present algorithm.

On the other hand, when the touch on the object has not been released, the electronic device again compares the duration time of the touch on the object with the reference time in step 203.

When the duration time of the touch on the object exceeds the reference time in step 203, the electronic device activates the object selection mode in step 205. In this case, the electronic device recognizes the touch point on the object as a reference point for object selection. In addition, the electronic device may display the activation information of the object selection mode on the display unit 110. For example, the electronic device displays objects displayed on the screen of the electronic device to jiggle at certain time intervals. In another example, the electronic device may display the background of the screen such that the brightness thereof is darker than that of the same before the activation of the object selection mode. In another example, the electronic device may display a popup window including the activation information of the object selection mode. In another example, the electronic device may display an icon for the object selection mode.

Thereafter, the electronic device determines whether a drag on the screen is detected in step 207. For example, the electronic device determines whether a drag 303 starting from a touch point 301 on an object is detected as illustrated in FIG. 3B. When the drag is not detected, the electronic device repeats step 207.

When the drag is detected, the electronic device selects at least one object in consideration of the touch point on the object and the drag information in step 209. For example, as illustrated in FIG. 3B, when the drag 303 starting from the touch point 301 on the object is detected, the electronic device selects object 1, object, 2, object 3, object 6, object 5, and object 8, which exist on a drag path. In this case, the electronic device displays selection such that the selected objects are distinguished from unselected objects.

As described above, after selecting at least one object, the electronic device determines whether a control event is generated in step 211. For example, when at least one object is selected as illustrated in FIG. 3B, the electronic device displays control menu items 311, 313 and 315. Accordingly, after selecting the objects, the electronic device determines whether a touch is generated on any one control menu item of the control menu items 311, 313 and 315 displayed on the display unit 110. When the control event is not generated, the electronic device returns to step 211.

When the control event is generated, the electronic device processes the at least one object selected at step 209 according to the kind of the control event in step 213. For example, when a touch on “delete selection” 311 of FIG. 3B is detected, the electronic device deletes the at least one object selected at step 209. In another example, when a touch on “move selection” 313 of FIG. 3B is detected, the electronic device changes the location of the at least one object selected at step 209 in consideration of touch information generated additionally. In another example, when a touch on “release selection” 315 of FIG. 3B is detected, the electronic device releases selection display on the at least one object selected at step 209.

Thereafter, the electronic device ends the present algorithm.

In the above-described exemplary embodiment, the electronic device having a touchscreen determines whether a drag is detected after an object selection mode has been activated. If the drag is not detected within a first reference time after the object selection mode has been activated, the electronic device may terminate the object selection mode.

In addition, after selecting an object, the electronic device having a touchscreen determines whether a control event is generated. If the control event is not detected within a second reference time after the object selection mode has been activated, the electronic device may cancel object selection.

As described above, an electronic device having a touchscreen can easily select a plurality of objects adjacent to each other in consideration of drag information generated from a touch point on an object.

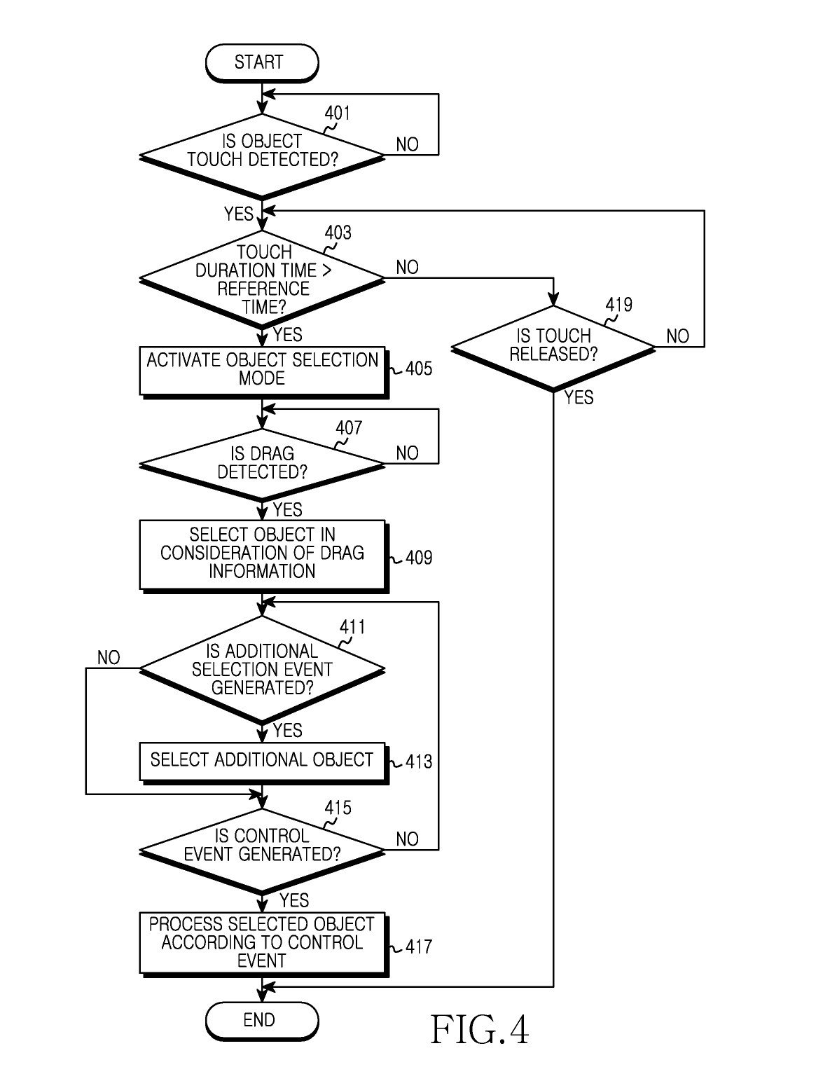

In another exemplary embodiment, the electronic device having a touchscreen may select a plurality of objects which are not adjacent to each other as illustrated in FIG. 4.

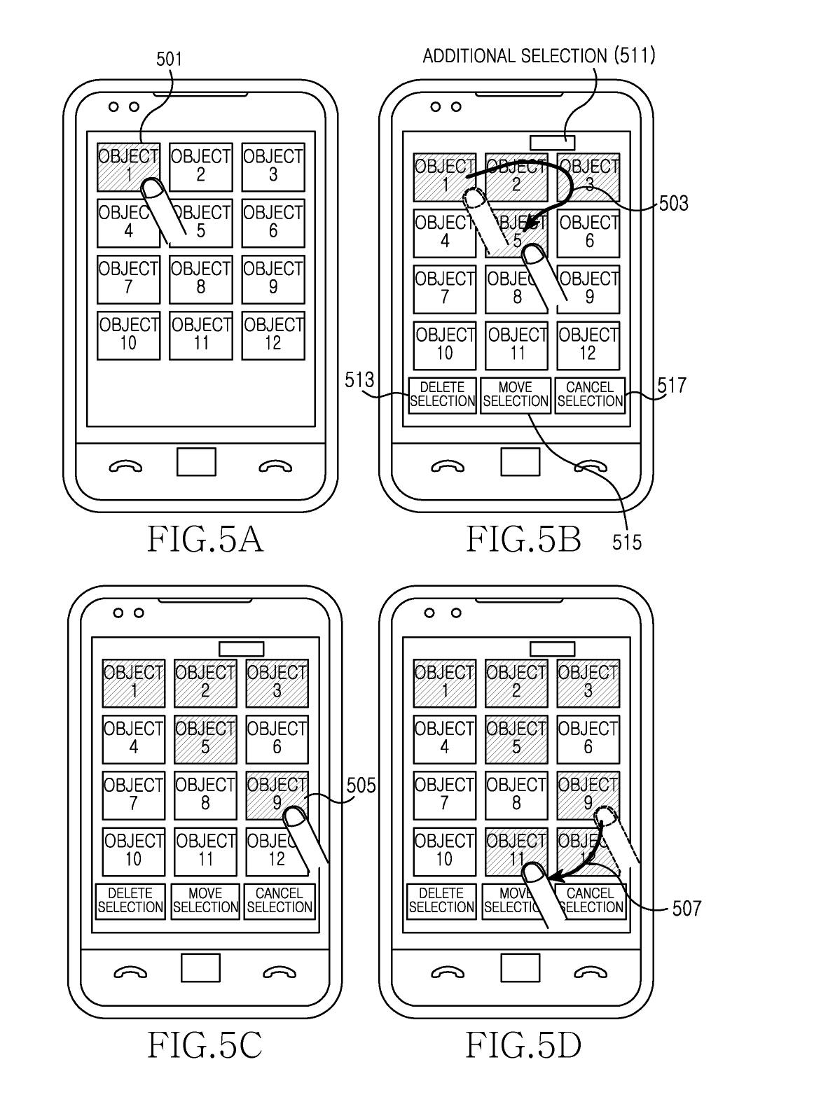

FIG. 4 illustrates a process for selecting an object in an electronic device having a touchscreen according to a second exemplary embodiment of the present invention. FIGS. 5A through 5D illustrate screen configurations for object selection in the electronic device having a touchscreen according to the second exemplary embodiment of the present invention.

Referring to FIGS. 4 through 5D, an electronic device having a touchscreen determines whether an object touch is detected in step 401. That is, the electronic device determines whether a touch on object 1 501 is detected as illustrated in FIG. 5A. When the object touch is not detected, the electronic device returns to step 401.

When the object touch is detected, the electronic device compares the duration time of the touch on the object with a reference time in step 403. That is, the electronic device determines whether the duration time of the touch on the object exceeds the reference time.

When the duration time of the touch on the object is smaller than or identical to the reference time, the electronic device determines whether the touch on the object is released in step 419.

When the touch on the object has been released, the electronic device ends the present algorithm.

On the other hand, when the touch on the object has not been released, the electronic device again compares the duration time of the touch on the object with the reference time in step 403.

When the duration time of the touch on the object exceeds the reference time in step 403, the electronic device activates the object selection mode in step 405. In this case, the electronic device recognizes the object touch point as a reference point for object selection. In addition, the electronic device may display the activation information of the object selection mode on the display unit 110. For example, the electronic device displays objects displayed on the screen of the electronic device to jiggle at certain time intervals. In another example, the electronic device may display the background of the screen such that the brightness thereof is darker than that of the same before the activation of the object selection mode. In another example, the electronic device may display a popup window including the activation information of the object selection mode. In another example, the electronic device may display an icon for the object selection mode.

Thereafter, the electronic device determines whether a drag on the screen is detected in step 407. For example, the electronic device determines whether a drag 503 starting from a touch point 501 on an object is detected as illustrated in FIG. 5B. When the drag is not detected, the electronic device repeats step 407.

When the drag is detected, the electronic device selects at least one object in consideration of the touch point on the object and the drag information in step 409. For example, as illustrated in FIG. 5B, when the drag 303 starting from the touch point 501 on the object is detected, the electronic device selects object 1, object, 2, object 3, and object 5, which exist on a drag path. In this case, the electronic device displays selection such that the selected objects are distinguished from unselected objects.

Then, the electronic device determines whether an additional selection event is generated in step 411. For example, when at least one object is selected as illustrated in FIG. 5B, the electronic device displays an additional selection icon 511. Accordingly, the electronic device determines whether selection of the additional selection icon 511 is detected.

When the additional selection event is not generated, the electronic device determines whether a control event is generated in step 415.

On the other hand, when the additional selection event is generated, the electronic device additionally selects an object in consideration of additional touch information detected in step 413. For example, when the additional selection icon 511 shown in FIG. 5B is touched, the electronic device perceives that the additional selection event has been generated. Then, the electronic device additionally selects an object according the tab information of a user. In this case, the tab represents a series of operations in which the user presses the touchscreen and then releases the touch. In another example, when the additional selection icon 511 shown in FIG. 5B is touched, the electronic device perceives that the additional selection event has been generated. Thereafter, when object 9 is touched 505 as illustrated in FIG. 5C, and the touch 505 on object 9 is maintained for a predetermined time or more, the electronic device recognizes the touch point 505 on object 9 as an additional reference point for additional selection of objects. Then, when a drag 507 starting from the touch point 505 on object 9 as illustrated in FIG. 5D is detected, the electronic device additionally selects object 9, object 12 and object 11 which exist on a drag path. In this case, the electronic device displays selection such that the selected objects are distinguished from unselected objects.

Thereafter, the electronic device determines whether a control event is generated in step 415. For example, when at least one object is selected as illustrated in FIGS. 5B to 5D, the electronic device displays control menu items 513, 515 and 517. Accordingly, after selecting the objects, the electronic device determines whether a touch is generated on any one control menu item of the control menu items 513, 515 and 517 displayed on the display unit 110.

When the control event is generated, the electronic device processes the at least one object selected at step 409 and step 413 according to the kind of the control event in step 417. For example, when a touch on “delete selection” 513 of FIG. 5B is detected, the electronic device deletes at least one object selected at step 409 and step 413. In another example, when a touch on “move selection” 515 of FIG. 5B is detected, the electronic device changes the location of the at least one object selected at step 409 and step 413 in consideration of additional touch information. In another example, when a touch on “release selection” 517 of FIG. 5B is detected, the electronic device releases selection display on the at least one object selected at step 409 and step 413.

Thereafter, the electronic device ends the present algorithm.

In the above-described exemplary embodiment, the electronic device having a touchscreen determines whether a drag is detected after the object selection mode has been activated. If a drag is not detected within a first reference time after the object selection mode has been activated, the electronic device may terminate the object selection mode.

In addition, after selecting an object, the electronic device having a touchscreen determines whether an additional selection event or a control event is generated. If the additional selection event or the control event is not generated within a second reference time after the object selection mode has been activated, the electronic device may cancel object selection.

In the following description, a method for setting an object selection area and selecting an object in an electronic device having a touchscreen is described.

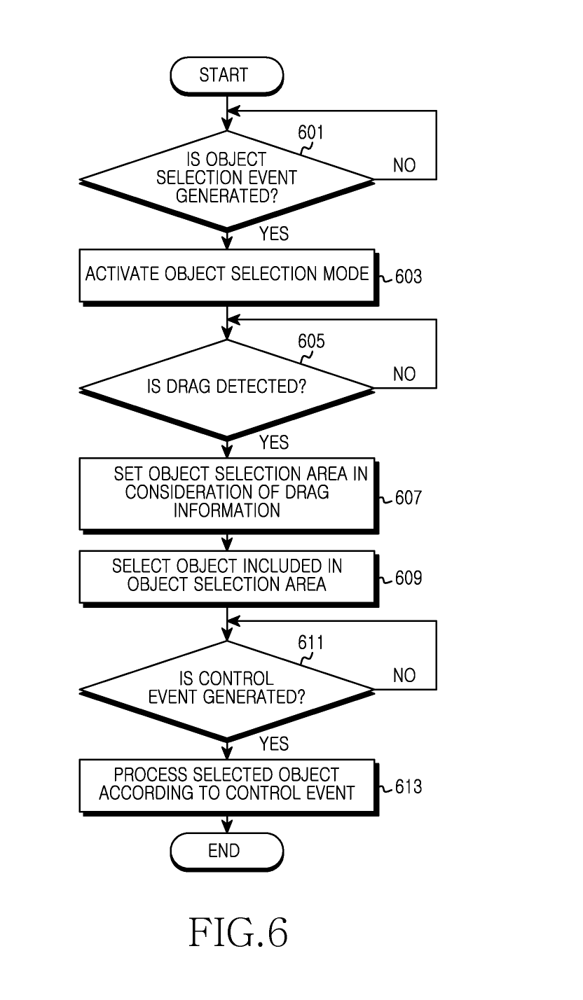

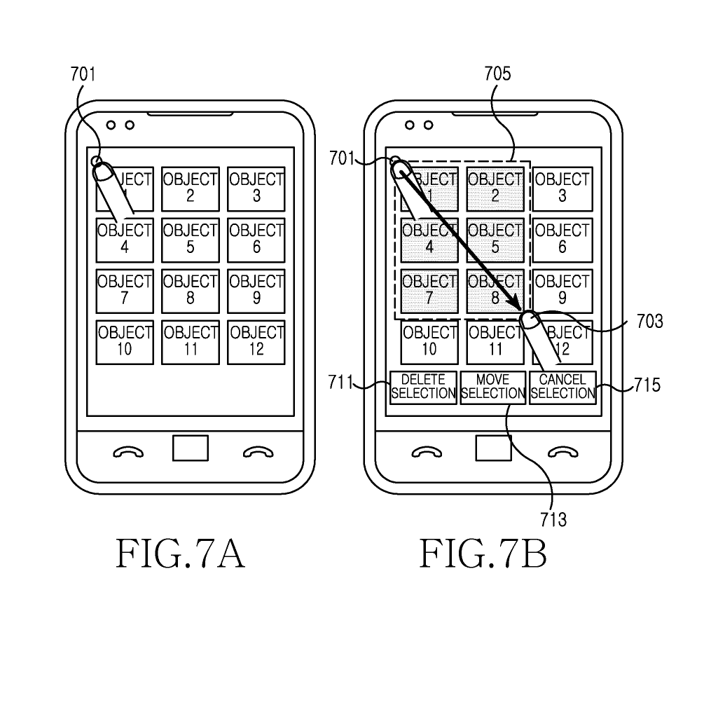

FIG. 6 illustrates a process for selecting an object in an electronic device having a touchscreen according to a third exemplary embodiment of the present invention. FIGS. 7A and 7B illustrates a screen configuration for object selection in the electronic device having a touchscreen according to the third exemplary embodiment of the present invention.

Referring to FIGS. 6 through 7B, an electronic device having a touchscreen determines whether an object selection event is generated in step 601. For example, the electronic device determines whether a touch on an object is maintained for a reference time or more. If the touch on an object is maintained for the reference time or more, the electronic device perceives that the object selection event has been generated. In another example, the electronic device determines whether an object selection icon is selected. If a touch on the object selection icon is detected, the electronic device perceives that the object selection event is generated. In another example, the electronic device determines whether a touch on an area 701 in which an object is not located on a screen as illustrated in FIG. 7A is maintained for a reference time or more. If the touch is maintained for the reference time or more, the electronic device perceives that the object selection event is generated. When the object selection event is not generated, the electronic device returns to step 601.

When the object selection event is generated, the electronic device activates the object selection mode in step 603. In this case, the electronic device may display the activation information of the object selection mode on the display unit 110. For example, the electronic device displays objects displayed on the screen of the electronic device to jiggle at certain time intervals. In another example, the electronic device may display the background of the screen such that the brightness thereof is darker than that of the same before the activation of the object selection mode. In another example, the electronic device may display a popup window including the activation information of the object selection mode. In another example, the electronic device may display an icon for the object selection mode.

Thereafter, the electronic device determines whether a drag on the screen is detected in step 605. For example, the electronic device determines whether a drag 703 starting from a first touch point 701 is detected as illustrated in FIG. 7B. When the drag is not detected, the electronic device repeats step 605.

When the drag is detected, the electronic device selects at least one object in consideration of the touch point on the object and the drag information in step 607. For example, as illustrated in FIG. 7B, when the drag 703 starting from the first touch point 701 is detected, the electronic device sets an object selection area 705 in consideration of the first touch point 701 and the drag information 703.

When setting the object selection area, the electronic device selects at least one object included in the object selection area in step 609. For example, the electronic device selects object 1, object, 2, object 4, object 5, object 7, and object 8, which are included in the object selection area 705 as illustrated in FIG. 7B. In this case, the electronic device displays selection such that the selected objects are distinguished from unselected objects.

As described above, after selecting the at least one object, the electronic device determines whether a control event is generated in step 611. For example, when at least one object is selected as illustrated in FIG. 7B, the electronic device displays control menu items 711, 713 and 715. Accordingly, after selecting the objects, the electronic device determines whether a touch is generated on any one control menu item of the control menu items 711, 713 and 715 displayed on the display unit 110. When the control event is not generated, the electronic device returns to step 611.

When the control event is generated, the electronic device processes the at least one object selected at step 609 according to the kind of the control event in step 613. For example, when a touch on “delete selection” 711 of FIG. 7B is detected, the electronic device deletes the at least one object selected at step 609. In another example, when a touch on “move selection” 713 of FIG. 7B is detected, the electronic device changes the location of the at least one object selected at step 609 in consideration of touch information generated additionally. In another example, when a touch on “release selection” 715 of FIG. 7B is detected, the electronic device releases selection display on the at least one object selected at step 609.

Thereafter, the electronic device ends the present algorithm.

As described above, the electronic device having a touchscreen selects an object included in the object selection area which is set in consideration of drag information. Thereafter, the electronic device may additionally select an object according to an additional selection event such as the additional selection event described above with respect to steps 411 and 413 of FIG. 4.

In the above-described exemplary embodiment, the electronic device having a touchscreen determines whether a drag is detected after the object selection mode has been activated. If a drag is not detected within a first reference time after the object selection mode has been activated, the electronic device may terminate the object selection mode.

In addition, after selecting an object, the electronic device having a touchscreen determines whether a control event is generated. If, after the object has been selected, the control event is not generated within a second reference time, the electronic device may cancel object selection.

In the above described exemplary embodiment, the electronic device having a touchscreen sets the object selection area in consideration of drag information.

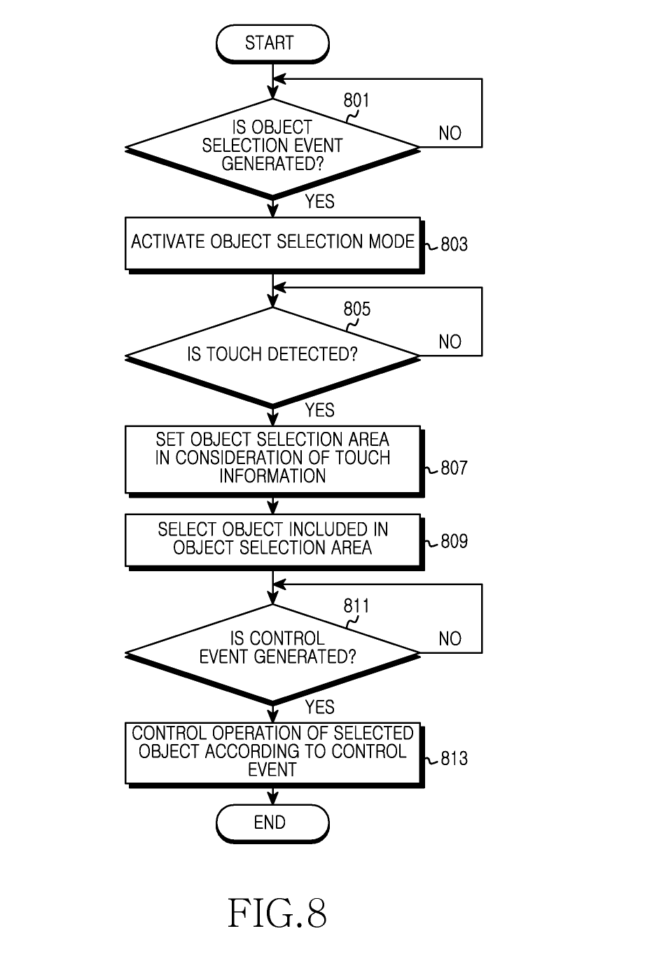

According to another exemplary embodiment, the electronic device having a touchscreen may set an object selection area in consideration of additional tab information as illustrated in FIG. 8 below.

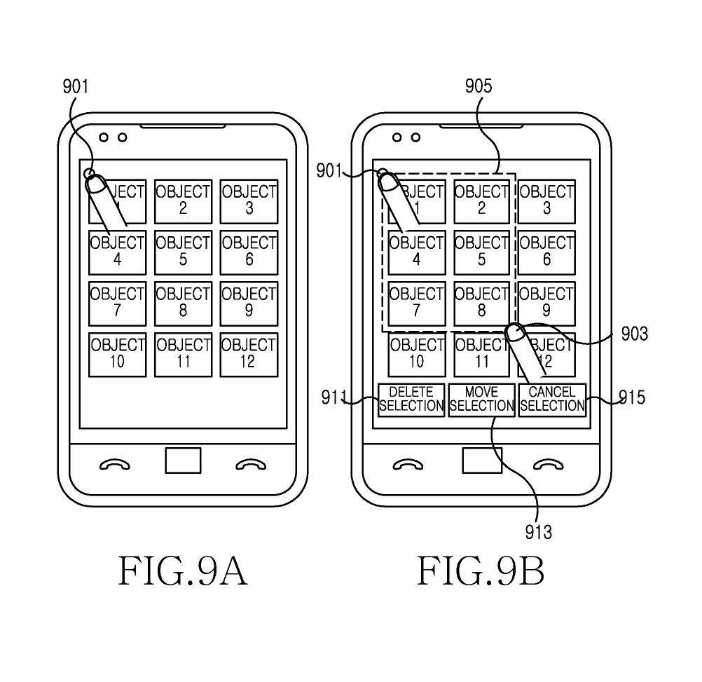

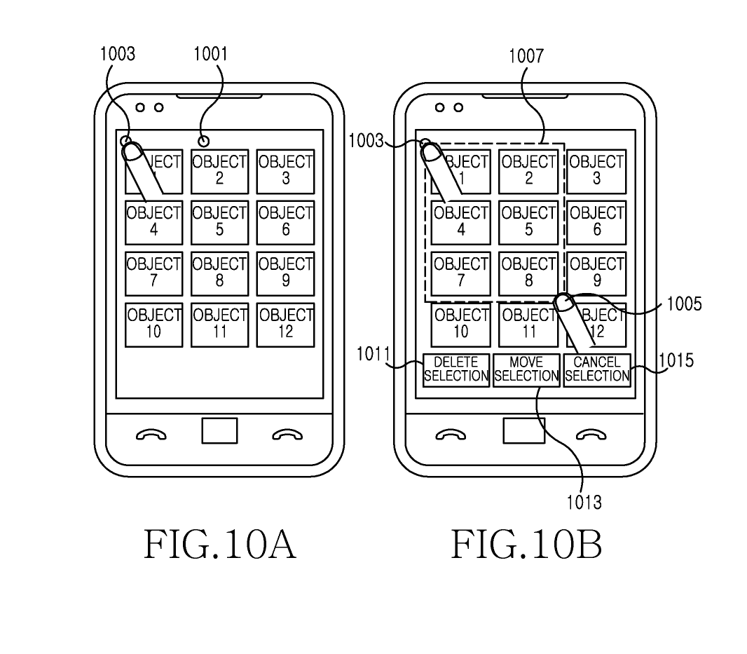

FIG. 8 illustrates a process for selecting an object in an electronic device having a touchscreen according to a fourth exemplary embodiment of the present invention. FIGS. 9A and 9B illustrate screen configurations for object selection in the electronic device having a touchscreen according to the fourth exemplary embodiment of the present invention. FIGS. 10A and 10B illustrate screen configurations for object selection in the electronic device having a touchscreen according to a fifth exemplary embodiment of the present invention.

Referring to FIGS. 8 through 10B, an electronic device having a touchscreen determines whether an object selection event is generated in step 801. For example, the electronic device determines whether a touch on an object is maintained for a reference time or more. If the touch on an object is maintained for the reference time or more, the electronic device perceives that the object selection event has been generated. In another example, the electronic device determines whether an object selection icon is selected. If a touch on the object selection icon is detected, the electronic device perceives that the object selection event is generated. In another example, the electronic device determines whether a touch on an area 901 in which an object is not located on a screen as illustrated in FIG. 9A is maintained for a reference time or more. If the touch is maintained for the reference time or more, the electronic device perceives that the object selection event is generated. When the object selection event is not generated, the electronic device returns to step 801.

When the object selection event is generated, the electronic device activates the object selection mode in step 803. In this case, the electronic device may display the activation information of the object selection mode on the display unit 110. For example, the electronic device displays objects displayed on the screen of the electronic device to jiggle at certain time intervals. In another example, the electronic device may display the background of the screen such that the brightness thereof is darker than that of the same before the activation of the object selection mode. In another example, the electronic device may display a popup window including the activation information of the object selection mode. In another example, the electronic device may display an icon for the object selection mode.

Thereafter, the electronic device determines whether a touch is detected in step 805. For example, when a touch on an area 901 in which an object is not located on a screen as illustrated in FIG. 9A is maintained for a reference time or more and an object selection event is then generated, the electronic device determines whether an additional touch 903 is detected as illustrated in FIG. 9B. In another example, when a touch on an object is maintained for a reference time or more and the object selection event is then generated, the electronic device determines whether the additional touch 903 is detected as illustrated in FIG. 9B. In another example, when a touch on an area 1001 in which an object is not located on the screen as illustrated in FIG. 10A is maintained for a reference time or more and the object selection event is then generated, the electronic device determines whether a plurality of touches, such as the second point 1003 of FIG. 10A and the third point 1005 of FIG. 10B, are detected. When the touch is not detected, the electronic device returns to step 805.

When the touch is detected, the electronic device selects at least one object in consideration of a plurality of pieces of touch information in step 807. For example, as illustrated in FIG. 9B, the electronic device sets an object selection area 905 in consideration of a first touch point 901 and an additional touch point 903 as illustrated in FIG. 9B. In another example, the electronic device sets an object selection area 1007 in consideration of a second touch point 1001 and a third touch point 1005 as illustrated in FIG. 10B.

When setting the object selection area, the electronic device selects at least one object included in the object selection area in step 809. For example, the electronic device selects object 1, object, 2, object 4, object 5, object 7, and object 8, which are included in the object selection area 905 as illustrated in FIG. 9B and FIG. 10B. In this case, the electronic device displays selection such that the selected objects are distinguished from unselected objects.

As described above, after selecting the at least one object, the electronic device determines whether a control event is generated in step 811. For example, when the at least one object is selected as illustrated in FIG. 9B or FIG. 10B, the electronic device displays control menu items 911 to 915 or 1011 to 1015. Accordingly, after selecting the objects, the electronic device determines whether a touch is generated on any one control menu item of the control menu items 911 to 915 or 1011 to 1015 displayed on the display unit 110. When the control event is not generated, the electronic device returns to step 811.

When the control event is generated, the electronic device processes the at least one object selected at step 809 according to the kind of the control event in step 813. For example, when a touch on “delete selection” 911 or 1011 of FIG. 9B or FIG. 10B is detected, the electronic device deletes the at least one object selected at step 809. In another example, when a touch on “move selection” 913 or 1013 of FIG. 9B or FIG. 10B is detected, the electronic device changes the location of the at least one object selected at step 809 in consideration of touch information generated additionally. In another example, when a touch on “release selection” 915 or 1015 of FIG. 9B or FIG. 10B is detected, the electronic device releases selection display on the at least one object selected at step 809.

Thereafter, the electronic device ends the present algorithm.

As described above, the electronic device having a touchscreen selects an object included in the object selection area which is set in consideration of additional touch information. Thereafter, the electronic device may additionally select an object according to an additional selection event, such as the additional selection event described above with reference to steps 411 and 413 of FIG. 4.

In the above-described exemplary embodiment, after the object selection mode has been activated, the electronic device having a touchscreen determines whether a touch for setting of the object selection area is detected. If, after the object selection mode has been activated, the touch for setting of the object selection area is not detected within a first reference time, the electronic device may terminate the object selection mode.

In addition, after selecting an object, the electronic device having a touchscreen determines whether a control event is generated. If, after the object has been selected, the control event is not generated within a second reference time, the electronic device may cancel object selection.

In the above described exemplary embodiment, the electronic device having a touchscreen selects an object using the object selection area which is set in consideration of additional tab information.

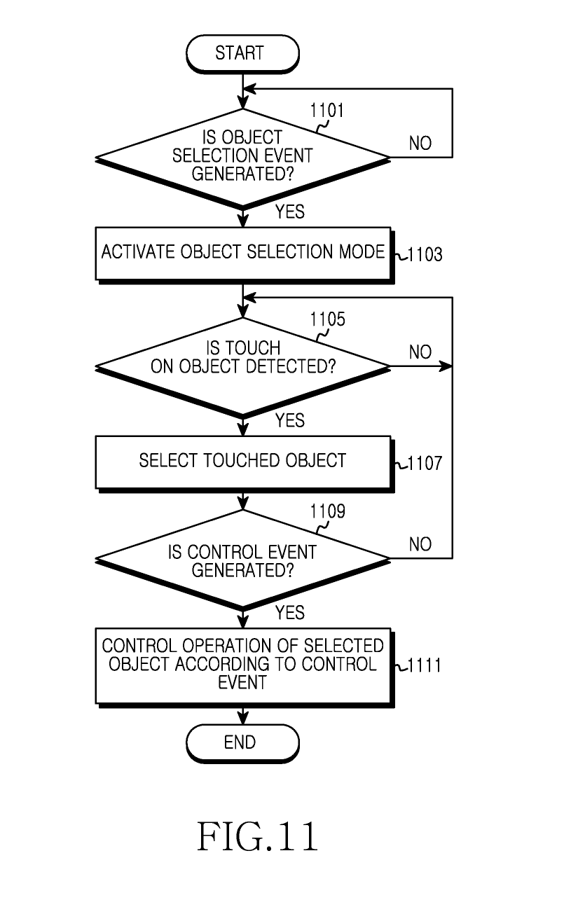

According to another exemplary embodiment, the electronic device having a touchscreen may select an object tabbed after the object selection event has been generated as illustrated in FIG. 11.

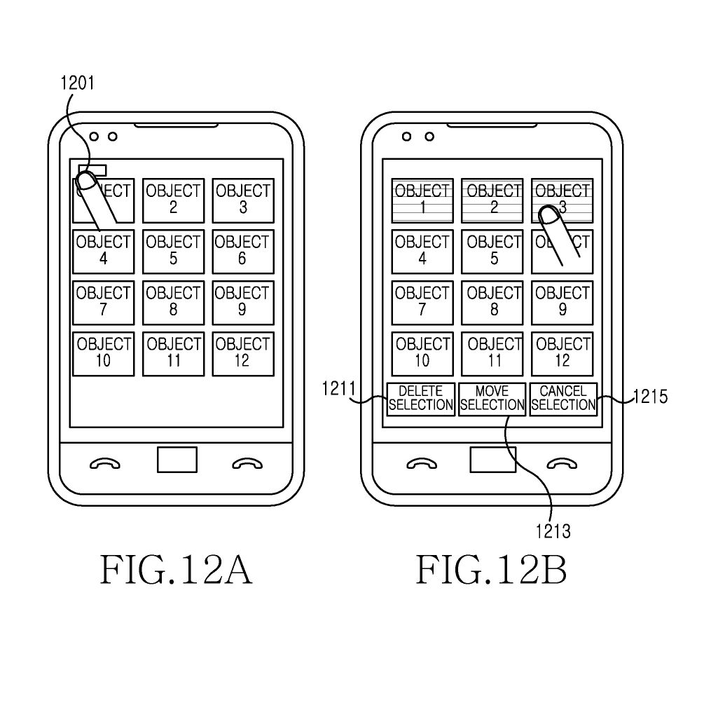

FIG. 11 illustrates a process for selecting an object in an electronic device having a touchscreen according to a fifth exemplary embodiment of the present invention. FIGS. 12A and 12B illustrate screen configurations for object selection in the electronic device having a touchscreen according to a sixth exemplary embodiment of the present invention.

Referring to FIGS. 11 through 12B, an electronic device having a touchscreen determines whether an object selection event is generated in step 1101. For example, the electronic device determines whether a touch on an object is maintained for a reference time or more. If the touch on an object is maintained for the reference time or more, the electronic device perceives that the object selection event has been generated. In another example, the electronic device determines whether an object selection icon is selected, such as object selection icon 1201 illustrated in FIG. 12A. If a touch on the object selection icon is detected, the electronic device perceives that the object selection event is generated. In another example, the electronic device determines whether a touch on an area in which an object is not located on a screen is maintained for a reference time or more. If the touch is maintained for the reference time or more, the electronic device perceives that the object selection event is generated. When the object selection event is not generated, the electronic device returns to step 1101.

When the object selection event is generated, the electronic device activates the object selection mode in step 1103. In this case, the electronic device may display the activation information of the object selection mode on the display unit 110. For example, the electronic device displays objects displayed on the screen of the electronic device to jiggle at certain time intervals. In another example, the electronic device may display the background of the screen such that the brightness thereof is darker than that of the same before the activation of the object selection mode. In another example, the electronic device may display a popup window including the activation information of the object selection mode. In another example, the electronic device may display an icon for the object selection mode.

Thereafter, the electronic device determines whether a touch on at least one object is detected in step 1005. For example, the electronic device determines whether a tab on an object is detected as illustrated in FIG. 12B. In this case, the tab represents a series of operations in which the user presses the touchscreen and then releases the touch. When a touch on at least one object is not detected, the electronic device returns to step 1105.

When a touch on at least one object is detected, the electronic device selects the tabbed at least one object in step 1107. For example, the electronic device selects object 1, object 2 and object 3 which are tabbed after the activation of the object selection mode as illustrated in FIG. 12B.

As described above, after selecting the at least one object, the electronic device determines whether a control event is generated in step 1109. For example, when the at least one object is selected as illustrated in FIG. 12B, the electronic device displays control menu items 1211 to 1215. Accordingly, after selecting the objects, the electronic device determines whether a touch is generated on any one control menu item of the control menu items 1211 to 1215 displayed on the display unit 110.

When the control event is not generated, the electronic device again determines whether a touch on the at least one object is detected in step 1105.

On the other hand, when the control event is generated, the electronic device processes the at least one object selected at step 1107 according to the kind of the control event in step 1111. For example, when a touch on “delete selection” 1211 of FIG. 12B is detected, the electronic device deletes the at least one object selected at step 1107. In another example, when a touch on “move selection” 1213 of FIG. 12B is detected, the electronic device changes the location of the at least one object selected at step 1107 in consideration of touch information generated additionally. In another example, when a touch on “release selection” 1215 of FIG. 12B is detected, the electronic device releases selection display on the at least one object selected at step 1107.

Thereafter, the electronic device ends the present algorithm.

In the above-described exemplary embodiment, after the object selection mode has been activated, the electronic device having a touchscreen determines whether a touch for object selection is detected. If, after the object selection mode has been activated, the touch for setting of the object selection area is not detected within a first reference time, the electronic device may terminate the object selection mode.

In addition, after selecting an object, the electronic device having a touchscreen determines whether a control event is generated. If, after the object has been selected, the control event is not generated within a second reference time, the electronic device may cancel object selection.

In the above-described exemplary embodiments, the electronic device having a touchscreen displays a control menu on the display unit 110 when the object is selected as illustrated in FIGS. 3A-3B, 5A-5D, 7A-7B, 9A-9B, 10A-10B and 12A-12B.

As described above, the exemplary embodiments of the present invention decreases time latency caused by selection of a plurality of objects by selecting the plurality of objects which are adjacent to each other in the electronic device having a touchscreen.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for selecting an object in an electronic device having a touchscreen, the method comprising:
when a first touch is detected, setting a point of the first touch as a first reference point; and
when movement of touch points from the first touch point is detected, selecting at least two objects, included in a first object selection area according to the first touch point and a first movement path of the touch points.

2. The method of claim 1, wherein the at least two objects each include at least one of an application icon, a widget, and a thumbnail image.

3. The method of claim 1, wherein the setting of the point of the first touch as the first reference point includes:
when the first touch is detected, determining a touch duration time of the first touch; and
setting the first touch point as the first reference point in consideration of the touch duration time of the first touch.

4. The method of claim 1, wherein the first object selection area has a linear structure extending linearly according to the first movement path of the touch points from the first touch point.

5. The method of claim 1, wherein the first object selection area has a spatial structure having an area extending according to the first movement path of the touch points from the first touch point.

6. The method of claim 1, further comprising:
when an additional object selection event is generated after the at least two objects have been selected, determining whether a second touch is detected; and
when the second touch is detected, additionally selecting at least one object in consideration of information about the second touch.

7. The method of claim 6, wherein the additionally selecting of the at least one object includes:
when the second touch is detected, setting a point of the second touch as a second reference point; and
when movement of touch points from the second touch point is detected, additionally selecting at least one object, included in a second object selection area according to the second touch point and a second movement path of the touch points.

8. The method of claim 1, wherein the selecting of the at least two objects includes displaying selection such that the at least two objects included in the first object selection area are distinguished from unselected objects.

9. The method of claim 1, further comprising:
when a control event is generated after the at least two objects have been selected, determining a control function according to the control event; and
processing the at least two objects selected according to the control function.

10. An electronic device comprising:
a touchscreen; and
a control unit for, when a first touch is detected, setting a point of the first touch as a first reference point, and, when movement of touch points from the first touch point is detected, selecting at least two objects included in a first object selection area according to the first touch point and a first movement path of the touch points.

11. The electronic device of claim 10, wherein the at least two objects each include at least one of an application icon, a widget, and a thumbnail image.

12. The electronic device of claim 10, wherein the control unit, when the first touch is detected, sets the first touch point as the first reference point in consideration of a touch duration time of the first touch.

13. The electronic device of claim 10, wherein the first object selection area has a linear structure extending linearly according to the first movement path of the touch points from the first touch point.

14. The electronic device of claim 10, wherein the first object selection area has a spatial structure having an area extending according to the first movement path of the touch points from the first touch point.

15. The electronic device of claim 10, wherein the control unit, when an additional object selection event is generated after the at least two objects have been selected, determines whether a second touch is detected through the touchscreen, and, when the second touch is detected, additionally selects at least one object in consideration of information about the second touch.

16. The electronic device of claim 15, wherein the control unit, when the second touch is detected through the touchscreen, sets a point of the second touch as a second reference point, and, when movement of touch points from the second touch point is detected, additionally selects at least one object included in a second object selection area according to the second touch point and a second movement path of the touch points.

17. The electronic device of claim 10, wherein the control unit displays selection such that the at least two objects included in the first object selection area according to the first touch point and the first movement path of the touch points are distinguished from unselected objects.

18. The electronic device of claim 10, wherein the control unit, when a control event is generated after the at least two objects have been selected, processes the at least two objects according to a control function corresponding to the control event.

19. A method for selecting an object in an electronic device having a touchscreen, the method comprising:
when a first touch is detected, determining whether an object selection event is generated in consideration of a touch duration time of the first touch;
when the object selection event is generated, determining whether at least two touches are detected; and
when a second touch and a third touch are detected, selecting at least two objects, included in an object selection area according to a point of the second touch and a point of the third touch.

20. The method of claim 19, wherein the object includes at least one of an application icon, a widget, and a thumbnail image.

21. The method of claim 19, wherein the object selection area has a spatial structure having an area extending according to locations of the second touch point and the third touch point.

22. An electronic device comprising:
a touchscreen; and
a control unit for, when a first touch is detected through the touchscreen, determining whether an object selection event is generated in consideration of a touch duration time of the first touch, and, when the object selection event is generated, selecting at least two objects, included in an object selection area according to a second touch point and a third touch point at which a second touch and a third touch are detected.

23. The electronic device of claim 22, wherein the object includes at least one of an application icon, a widget, and a thumbnail image.

24. The electronic device of claim 22, wherein the control unit selects at least two objects, included in the object selection area having a spatial structure having an area extending according to locations of the second touch point and the third touch point.
